(19) United States
(12) Patent Application Publication
(10) Pub. No.: US 2009/0079327 A1
(43) Pub. Date: Mar. 26, 2009

(54) GREEN LIGHT EMITTING PHOSPHOR AND LIGHT EMITTING DEVICE USING THE SAME

(75) Inventors: Hisayoshi DAICHO, Shizuoka-shi (JP); Takeshi IWASAKI, Shizuoka-shi (JP)

Correspondence Address: SUGHRUE-265550, 2100 PENNSYLVANIA AVE. NW, WASHINGTON, DC, 20037-3213, US

(73) Assignee: KOITO MANUFACTURING CO., LTD., Tokyo (JP)

(21) Appl. No.: 12/210,237

(22) Filed: Sep. 15, 2008

(30) Foreign Application Priority Data
Sep. 20, 2007 (JP) 2007-243534

(51) Int. Cl. H01J 1/62; C01F 17/00

(52) U.S. Cl. 313/503; 423/263

(57) ABSTRACT

A green light emitting phosphor and a light emitting device are provided. The green light emitting phosphor includes a composition represented by the formula Sr_{1.8-n}MₙEu_{0.2}Si₃O₈.2SrCl₂. M is at least one element selected from the group consisting of Ca, Ba, and Mg, and n is in a range of 0<n≦1.0. The light emitting device includes a semiconductor light emitting element which emits ultraviolet or short-wavelength visible light; and the green light emitting phosphor.

This application claims priority from Japanese Patent Application No. 2007-2 43534 filed on Sep. 20, 2007, the entire contents of which are hereby incorporated by reference.

### BACKGROUND OF THE INVENTION

1. Technical Field

Devices and compositions consistent with the present disclosure relate to green light emitting phosphors and light emitting devices that use the green light emitting phosphors.

2. Related Art

In recent times, white light emitting devices using light emitting diodes (LED) have been actively developed. In the white light emitting diodes, a yellow light emitting phosphor is combined with a blue LED chip to realize white light. However, in a light emitting device that emits white light overall by additive color mixing of blue light and yellow light, there are certain problems because an emission color of the obtained white light is limited, and a color rendering property is low, and there is a large non-uniformity in the emission color.

To address these problems, there has been suggested a white light emitting device in which red, green, and blue phosphors are combined with an ultraviolet or short-wavelength visible light LED chip.

Specifically, as the blue light emitting phosphor, there are BaMgAl₁₀O₁₇:Eu; (Sr, Ca, Ba)₅(PO₄)₃Cl:Eu; and the like. As the green light emitting phosphor, there are ZnS:Cu, Al; BaMgAl₁₀O₁₇:Eu, Mn; and the like. As the red light emitting phosphor, there are Y₂O₂S:Eu; La₂O₂S:Eu; and the like.

However, in the above-described phosphors, there are disadvantages in that light emission efficiency thereof is low at the time of excitation when using ultraviolet or short-wavelength visible light and thus it is difficult to obtain sufficient light flux. As for the green light emitting phosphor having the highest visibility, the ZnS:Cu, Al has low light resistance, the BaMgAl₁₀O₁₇:Eu,Mn has a peak at a light emission wavelength near 515 nm, and a light emission intensity near 555 nm representing the maximum visibility is low. Thus, it is difficult to obtain sufficient brightness in the case of additive color mixing.

In a fluorescent lamp having high brightness and a high color rendering property formed by mixing three colors of blue, green, and red, LaPO₄:Ce,Tb; La₂O₃.0.9P₂O₅.0.2SiO₂:Ce,Tb; GdMgB₅O₁₀:Ce,Tb; CeMgAl₁₁O₁₉:Tb; and the like are used as the green light emitting phosphor, and bright-line emitted light near 545 nm caused by Tb³⁺ is used. However, the excitation wavelength of such a phosphor is 300 nm or less, and thus it is difficult to combine the phosphor with the LED emitting ultraviolet or short-wavelength visible light.

In addition, JP-A-2002-105449 and JP-A-2005-232305 describe a phosphor excited by long-wavelength ultraviolet rays to emit light, such as Ce—Tb activated yttrium silicate or Ce—Tb activated calcium aluminate. However, a light emission intensity thereof is not yet sufficient.

### SUMMARY OF THE INVENTION

Exemplary embodiments of the present invention address the above disadvantages and other disadvantages not described above. However, the present invention is not required to overcome the disadvantages described above, and thus, an exemplary embodiment of the present invention may not overcome any of the problems described above.

It is an aspect of the present invention to provide a green light emitting phosphor having improved light emission intensity, and to produce a white light emitting device having a high color rendering property and high brightness, using the green light emitting phosphor.

According to one or more illustrative aspects of the present invention, there is provided a green light emitting phosphor. The green light emitting phosphor includes a composition represented by the formula: Sr_{1.8-n}MₙEu_{0.2}Si₃O₈.2SrCl₂. M is at least one element selected from the group consisting of Ca, Ba, and Mg, and n is in a range of 0<n≦1.0.

According to one or more illustrative aspects of the present invention, there is provided a light emitting device. The light emitting device includes a semiconductor light emitting element which emits ultraviolet or short-wavelength visible light; and the green light emitting phosphor.

According to the present invention, the phosphor is efficiently excited by ultraviolet or short-wavelength visible light to emit green light with high emission brightness. The light emitting device using the phosphor has high light emission efficiency, and has excellent light emission properties.

### BRIEF DESCRIPTION OF THE DRAWINGS

FIG. 1 is a diagram illustrating light emission spectrum distributions of green light emitting phosphors of Example 4 according to an exemplary embodiment of the present invention, and Comparative Examples 1 and 2;

FIG. 2 is a diagram illustrating excitation spectrum distributions of green light emitting phosphors of Example 4 according to an exemplary embodiment of the present invention, and Comparative Examples 1 and 2; and

FIG. 3 is a longitudinal sectional view illustrating a light emitting device using a green light emitting phosphor according to an exemplary embodiment of the present invention.

### DETAILED DESCRIPTION OF EXEMPLARY EMBODIMENTS OF THE PRESENT INVENTION

A green light emitting phosphor according to an exemplary embodiment of the invention is represented by the following formula.

Sr_{1.8-n}MₙEu_{0.2}Si₃O₈.2SrCl₂

M is at least one element selected from Ca, Ba, and Mg, and n is a numeral satisfying the condition of 0<n≦1.0.

In the composition of the element included in the phosphor, it is advantageous if n is in the range of 0.3≦n≦0.7.

In the green light emitting phosphor represented by the formula, an excitation peak wavelength is in the range of about 350 to about 420 nm, with additional advantages in the range of about 350 to about 380 nm. An LED device or a high-pressure mercury lamp mainly using ultraviolet ray may be used as an excitation source.

The green light emitting phosphor of the invention using the LED device or high-pressure mercury lamp as the excitation source has a light emission peak at a wavelength of about 500 nm, and emits light in the wide range of the peak emission wavelength to the long wavelength (about 500 to about 700 nm).

The green light emitting phosphor may be used for a light emitting device by combining the green light emitting phosphor with a semiconductor light emitting element that emits ultraviolet or short-wavelength visible light and another color light emitting phosphor. For example, the phosphor according to an exemplary embodiment of the invention may be combined with an ultraviolet semiconductor light emitting element and red and blue light emitting phosphors to form a white light emitting device. The red and blue phosphors are not limited particularly. For example, phosphors for public and common uses may be used.

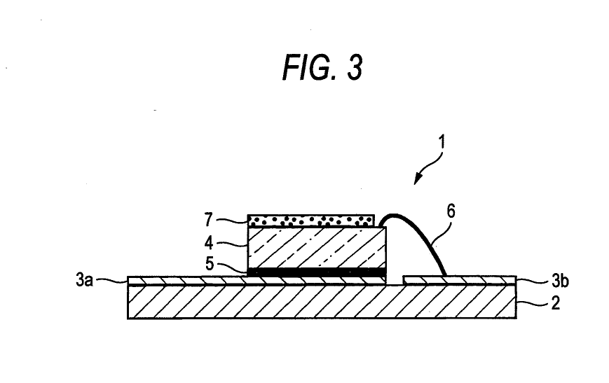

FIG. 3 is a schematic sectional view illustrating a light emitting device according to an exemplary embodiment of the present invention.

In a light emitting device 1 shown in FIG. 3, an electrode 3a and an electrode 3b are formed on a substrate 2. A semiconductor light emitting element 4 is fixed onto the electrode 3a by a mount member 5. The semiconductor light emitting element 4 and the electrode 3a are electrically coupled to each other by the mount member 5, and the semiconductor light emitting element 4 and the electrode 3b are electrically coupled to each other by a wire 6. A fluorescent layer 7 is formed on the semiconductor light emitting element 4.

The substrate 2 is formed of a material having no conductivity but high thermal conductivity, for example, a ceramic substrate such as aluminum nitride, alumina substrate, mullite substrate, or glass ceramic substrate, or a glass epoxy substrate.

The electrodes 3a and 3b are conductive layers formed of metal materials such as gold, copper, etc.

The semiconductor light emitting element 4 is an example of a light emitting element used in the light emitting device according to an exemplary embodiment of the present invention. For example, an LED or a laser diode (LD) that emits ultraviolet or short-wavelength visible light, e.g., an InGaN-based compound semiconductor may be used. The InGaN-based compound semiconductor has a wavelength band changed depending on a content of In. As the content of In becomes large, a light emission wavelength thereof tends to shift toward a long wavelength side. As the content becomes small, the light emission wavelength tends to shift toward a short wavelength side.

The mount member 5 is a conductive adhesive such as silver paste, by which the lower face of the semiconductor 4 is fixed onto the electrode 3a, and the electrode 3a formed on the substrate 2 is electrically coupled to an electrode formed on the lower face of the semiconductor light emitting element 4.

The wire 6 is a conductive member such as a gold wire. The wire 6 is bonded to the electrode 3b and an electrode formed on the upper face of the semiconductor light emitting element 4, for example, by ultrasonic thermal compression, thereby electrically coupling both the electrode 3b and the electrode.

In the fluorescent layer 7, the above-described phosphor is sealed in a film-shape by a binder member and covers the upper face of the semiconductor light emitting element 4. The fluorescent layer 7 is formed, for example, such that a phosphor paste is produced by mixing a phosphor with a liquid or gel binder member, the phosphor paste is applied onto the upper face of the semiconductor light emitting element 4, and then the binder member of the applied phosphor paste is hardened.

For example, silicone resin or fluorine resin may be used as the binder member. Particularly, since the light emitting device according to an exemplary embodiment of the invention uses ultraviolet or short-wavelength visible light as an excitation source, it is advantageous to use a binder member having high ultraviolet resistance.

In the fluorescent layer 7, one or more kinds of phosphors having a light emission property different from that of the phosphor may be mixed. Accordingly, it is possible to obtain light having various colors by composing light having various kinds of wavelength bands.

In the fluorescent layer 7, materials having various properties of matter other than phosphors may be mixed. For example, materials having a refractive index higher than that of the binder member, such as metal oxides, fluorine compounds, or sulfides may be mixed into the fluorescent layer 7, thereby raising a refractive index of the fluorescent layer 7. Accordingly, it is possible to reduce total reflection occurring at the time of incidence of the light generated by the semiconductor light emitting element 4 to the fluorescent layer 7, and thus it is possible to improve incidence efficiency of the excitation light incident into the fluorescent layer 7. In addition, the materials having nano-size particle diameters are mixed, and thus it is possible to raise the refractive index without decrease in transparency of the fluorescent layer 7.

The light emitting device using the green light emitting phosphor according to an exemplary embodiment of the invention may have a configuration in which the fluorescent layer is provided on the semiconductor light emitting element.

In this case, as the fluorescent layer provided on the semiconductor light emitting element, one or more kinds of phosphors may be laminated in a single or multi layered shape, and a plurality of phosphors may be disposed in a single layer by mixing. As the type of the fluorescent layer provided on the semiconductor light emitting element, there are a type in which a phosphor is mixed with a coating member for coating the surface of the semiconductor light emitting element, a type in which a phosphor is mixed with a mold member, a type in which a phosphor is mixed with a coating material for coating a mold member, a type in which a light-permeable plate formed by mixing a phosphor is disposed in a transparent front side of a semiconductor light emitting element lamp, and the like. In the case of mixing with the mold member, it is advantageous to disperse the phosphor in silicone resin having high UV resistance.

### EXAMPLES

Hereinafter, the phosphor according to an exemplary embodiment of the present invention will be described in more detail with reference to Examples, but the present invention is not limited thereto.

### Example 1

Preparation of Sr_{1.7}Ca_{0.1}Eu_{0.2}Si₃O₈.2SrCl₂

SrCO₃, CaCO₃, SiO₂, Eu₂O₃, and SrCl₂ were weighed and mixed in a molar ratio of 1.7:0.1:3.0:0.2:2.0, and then the mixture was burned in an alumina crucible at 850° C. for 2 hours. After cooling the burned product, the burned product was pulverized by a mortar, then was put in an alumina crucible with a lid, and was burned in an atmosphere of reduction gas (atmosphere of N₂ including 2 to 5% of H₂) at 940° C. for 3 hours. The burned material was finely pulverized and washed clearly with warm pure water, and further it was filtrated and dried.

### Example 2

Preparation of Sr_{1.5}Ca_{0.3}Eu_{0.2}Si₃O₈.2SrCl₂

SrCO₃, CaCO₃, SiO₂, Eu₂O₃, and SrCl₂ were weighed and mixed in a molar ratio of 1.5:0.3:3.0:0.2:2.0, and then the mixture was burned in an alumina crucible at 850° C. for 2 hours. After cooling the burned product, the burned product was pulverized by a mortar, then was put in an alumina crucible with a lid, and then was burned in an atmosphere of reduction gas (atmosphere of N₂ including 2 to 5% of H₂) at 940° C. for 3 hours. The burned material was finely pulverized and washed clearly with warm pure water, and further it was filtrated and dried.

### Example 3

Preparation of Sr_{1.3}Ca_{0.5}Eu_{0.2}Si₃O₈.2SrCl₂

SrCO₃, CaCO₃, SiO₂, Eu₂O₃, and SrCl₂ were weighed and mixed in a molar ratio of 1.3:0.5:3.0:0.2:2.0, and then the mixture was burned in an alumina crucible at 850° C. for 2 hours. After cooling the burned product, the burned product was pulverized by a mortar, then was put in an alumina crucible with a lid, and then was burned in an atmosphere of reduction gas (atmosphere of N₂ including 2 to 5% of H₂) at 940° C. for 3 hours. The burned material was finely pulverized and washed clearly with warm pure water, and further it was filtrated and dried.

### Example 4

Preparation of Sr_{1.1}Ca_{0.7}Eu_{0.2}Si₃O₈.2SrCl₂

SrCO₃, CaCO₃, SiO₂, Eu₂O₃, and SrCl₂ were weighed and mixed in a molar ratio of 1.1:0.7:3.0:0.2:2.0, and then the mixture was burned in an alumina crucible at 850° C. for 2 hours. After cooling the burned product, the burned product was pulverized by a mortar, then was put in an alumina crucible with a lid, and then was burned in an atmosphere of reduction gas (atmosphere of N₂ including 2 to 5% of H₂) at 940° C. for 3 hours. The burned material was finely pulverized and washed clearly with warm pure water, and further it was filtrated and dried.

### Example 5

Preparation of Sr_{0.9}Ca_{0.9}Eu_{0.2}Si₃O₈.2SrCl₂

SrCO₃, CaCO₃, SiO₂, Eu₂O₃, and SrCl₂ were weighed and mixed in a molar ratio of 0.9:0.9:3.0:0.2:2.0, and then the mixture was burned in an alumina crucible at 850° C. for 2 hours. After cooling the burned product, the burned product was pulverized by a mortar, then was put in an alumina crucible with a lid, and then was burned in an atmosphere of reduction gas (atmosphere of N₂ including 2 to 5% of H₂) at 940° C. for 3 hours. The burned material was finely pulverized and washed clearly with warm pure water, and further it was filtrated and dried.

### Comparative Example 1

Preparation of Sr_{1.8}Eu_{0.2}Si₃O₈.2SrCl₂

SrCO₃, CaCO₃, SiO₂, Eu₂O₃, and SrCl₂ were weighed and mixed in a molar ratio of 1.8:0.0:3.0:0.2:2.0, and then the mixture was burned in an alumina crucible at 850° C. for 2 hours. After cooling the burned product, the burned product was pulverized by a mortar, then was put in an alumina crucible with a lid, and then was burned in an atmosphere of reduction gas (atmosphere of N₂ including 2 to 5% of H₂) at 940° C. for 3 hours. The burned material was finely pulverized and washed clearly with warm pure water, and further it was filtrated and dried.

### Comparative Example 2

As Comparative Example 2, a phosphor (produced by Kasei Optonix. Ltd.) represented by BaMgAl₁₀O₁₇:Eu,Mn was used. This phosphor is known for good light resistance in phosphors of green light emission of near-ultraviolet excitation listed in the Japanese government project “Logic Model of Development of Highly Efficient LED (Plan for Light of 21st-Century)”

Table 1 shows Ca contents, light emission peak wavelengths, excitation peak wavelengths, and light emission integration intensity ratios, with respect to Examples 1 to 5 and Comparative Examples 1 and 2. The excitation peak wavelengths are peak wavelengths in the range of 340 to 362 nm. The light emission integration intensity ratios are relative values, when the phosphors are irradiated with near-ultraviolet light of 400 nm and a light emission integration intensity of the phosphor of Comparative Example 2 is considered as 1.0

TABLE 1

| | | Light | | Light emission |
|---|---|---|---|---|
| | Ca | emission peak | Excitation peak | integration |
| | content | wavelength | wavelength | intensity |
| | n (mol) | (nm) | (nm) | ratio |
| Ex. 1 | 0.1 | 489 | 358 | 0.84 |
| Ex. 2 | 0.3 | 490 | 361 | 1.11 |
| Ex. 3 | 0.5 | 500 | 361 | 1.15 |
| Ex. 4 | 0.7 | 504 | 360 | 1.23 |
| Ex. 5 | 0.9 | 495 | 360 | 0.74 |
| Comp. 1 | 0 | 491 | 358 | 0.64 |
| Comp. 2 | — | 515 | 340 | 1.00 |

As can be seen from Table 1, the phosphors in Examples 2, 3, and 4 can obtain light emission integration intensity of about 1.11 to about 1.23 times as high as that of Comparative Example 2. In addition, Examples 1 and 5 show light emission integration intensity close to that of Comparative Example 2.

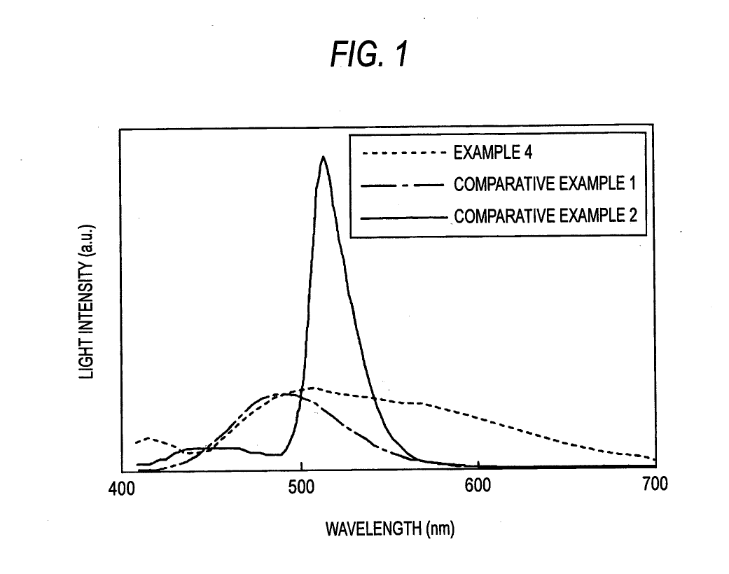

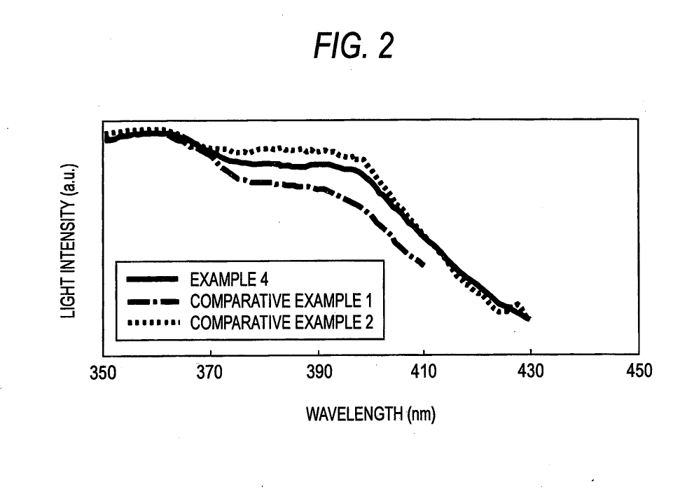

Comparative diagrams of light emission spectrums and excitation spectrums are shown in FIGS. 1 and 2, with respect to Example 4 having the highest light emission integration intensity among the phosphors of the invention, and Comparative Examples 1 and 2.

FIG. 1 shows light emission spectrums of Example 4 and Comparative Examples 1 and 2 when the phosphors are irradiated with near ultraviolet light having a wavelength of 400 nm from an LED device. FIG. 2 shows excitation spectrums of the phosphors shown in Example 4 and Comparative Examples 1 and 2. The vertical axis denotes relative light emission intensity, and the horizontal axis denotes light emission wavelength (nm).

As can be seen from FIG. 1, the phosphor according to an exemplary embodiment of the present invention has a peak wavelength near 500 nm, and emits light in a wide range from the peak emission wavelength to 700 nm. Even when the phosphors other than Example 4 are irradiated with the same near-ultraviolet light, the light emission spectrum having substantially the same shape as that of Example 4 is shown and there is a difference between light emission intensities. As can be seen from FIG. 2, the phosphor according to an exemplary embodiment of the present invention is efficiently excited by near-ultraviolet light, in the range of 350 to 420 nm as the peak wavelength of the excitation spectrum. Even when the phosphors other than Example 4 are irradiated with the same near-ultraviolet light, an excitation spectrum having substantially the same shape as that of Example 4 is shown. In FIG. 2, intensity peak positions of the spectrums are set to coincide with each other.

Table 2 shows total light flux ratios of white light emitting devices, in the case of using Example 4 of the phosphor according to an exemplary embodiment of the invention as a green phosphor component and mixing the phosphor with a blue light emitting phosphor and a red light emitting phosphor, and in the case of mixing the Comparative Example 1 and Comparative Example 2 with the blue light emitting phosphor and the red light emitting phosphor, when each of the mixed phosphors is irradiated with near-ultraviolet light having a wavelength of 400 nm from an LED device. The total light flux ratio is a relative value when a total light flux of a white light emitting device using Comparative Example 2 as a green light emitting phosphor is considered as 1.0. BaMgAl₁₀O₁₇:Eu²⁺ was used as the blue light emitting phosphor, and La₂O₂S:Eu³⁺ was used as the red light emitting phosphor. In the production of the white light emitting device, the combination of the phosphor was adjusted so that chromaticity coordinates fall within x=0.360 and y=0.365.

TABLE 2

| Green light emitting phosphor | Total light flux ratio |
|---|---|
| Ex. 4 | 2.0 |
| Comp. 1 | 1.2 |
| Comp. 2 | 1.0 |

As can be seen from Table 2, in the case of producing the white light emitting device using Example 4 of the phosphor according to an exemplary embodiment of the invention as a green light emitting phosphor, it is possible to obtain a total light flux ratio 2.0 times as high as that of Comparative Example 2. The phosphor according to an exemplary embodiment of the present invention has a wide light emission spectrum near 555 nm that is the maximum visibility. Accordingly, it can be seen that it is possible to produce a white light emitting device having a high color rendering property by using the phosphor according to an exemplary embodiment of the invention.

The phosphor according to an exemplary embodiment of the invention has been described above with reference to certain Examples thereof, but the present invention is not limited to these Examples. That is, it is natural that various modifications, improvements, combinations and use types are conceivable.

The light emitting device according to an exemplary embodiment of the present invention is applicable to various kinds of lamp fittings such as a lamp fitting for lighting, a display, a vehicle lamp, or a signaler.

While the present invention has been shown and described with reference to certain exemplary embodiments thereof, other implementations are within the scope of the claims. It will be understood by those skilled in the art that various changes in form and details may be made therein without departing from the spirit and scope of the invention as defined by the appended claims.

What is claimed is:

1. A green light emitting phosphor comprising a composition represented by the formula:
Sr_{1.8-n}MₙEu_{0.2}Si₃O₈.2SrCl₂,
wherein M is at least one element selected from the group consisting of Ca, Ba, and Mg, and n is in a range of 0<n≦1.0.

2. The green light emitting phosphor according to claim 1, wherein an excitation peak wavelength of the phosphor is in a range of about 350 to about 420 nm.

3. The green light emitting phosphor according to claim 1, wherein a peak wavelength of a light emission spectrum of the phosphor is about 500 nm, and the phosphor emits light in a range of about 500 nm to about 700 nm.

4. The green light emitting phosphor according to claim 2, wherein a peak wavelength of a light emission spectrum of the phosphor is about 500 nm, and the phosphor emits light in a range of about 500 nm to about 700 nm.

5. A light emitting device comprising:
a semiconductor light emitting element which emits ultraviolet or short-wavelength visible light; and
a green light emitting phosphor represented by the formula:
Sr_{1.8-n}MₙEu_{0.2}Si₃O₈.2SrCl₂,
wherein M is at least one element selected from the group consisting of Ca, Ba, and Mg, and n is in a range of 0<n≦1.0.
